(19) United States
(12) Patent Application Publication
(10) Pub. No.: US 2026/0079855 A1
(43) Pub. Date: Mar. 19, 2026

(54) Exception Vector Table Selection Using Processor Operating Mode

(71) Applicant: Apple Inc., Cupertino, CA (US)

(72) Inventors: Jeff Gonion, Campbell, CA (US); Alexander Donald Charles Chadwick, Cambridge (GB); Bernard J. Semeria, Palo Alto, CA (US)

(21) Appl. No.: 19/324,603

(22) Filed: Sep. 10, 2025

Related U.S. Application Data
(60) Provisional application No. 63/696,124, filed on Sep. 18, 2024.

(51) Int. Cl. G06F 12/14; G06F 9/38; G06F 12/06

(52) U.S. Cl. CPC G06F 12/1491; G06F 9/3865; G06F 12/0607

(57) ABSTRACT

A processor circuit may include a mode transition circuit, an exception management circuit, and a plurality of circuits configured to assert respective exception signals. The mode transition circuit may be configured to select a particular one of a plurality of processor modes, corresponding to a respective set of memory access permissions. The exception management circuit may be configured to receive an indication of an assertion of a particular exception signal by a respective one of the plurality of circuits, and then select a vector table of a plurality of vector tables based on a determined processor mode of the plurality of processor modes. The exception management circuit may also be configured to, based on the particular exception signal, determine a vector address within the selected vector table and, based on the determined vector address, retrieve a particular exception handler address from the selected vector table.

The present application claims priority to U.S. Provisional App. No. 63/696,124, entitled “Exception Vector Table Selection Using Processor Operating Mode,” filed September 18, 2024, the disclosure of which is incorporated by reference herein in its entirety.

### BACKGROUND

### Technical Field

This disclosure relates generally to computer processors, and more specifically to the use of exception vector tables in a given computer processor.

### Description of the Related Art

Processors, also known as central processing units (CPUs), are the core components of computing devices that perform a wide range of computational tasks. These circuits are responsible for executing instructions within the processor’s instruction set architecture (ISA), managing data, and controlling the overall operation of a computer system. Processors are found in various devices, including personal computers, laptops, smartphones, servers, and embedded systems, powering the functionality and performance of these devices.

Some instructions in a processor’s ISA may be reserved for execution at a specific privilege level, which is typically determined at the time the instruction is executed. Most software executes at a relatively low level of privilege (e.g., an unprivileged privilege level), preventing the software from accessing and/or updating critical processor state and other protected resources (thus helping ensure security in the system). In many cases, such software cannot execute particular instructions that are restricted to more privileged levels. Parts of the operating system that do access/change such state, on the other hand, may execute at more privileged levels (e.g., a privileged privilege level). The number of privilege levels and the instructions that can be executed at each privilege level varies from ISA to ISA.

Permissions play a crucial role in the functioning of processors. A processor’s ability to execute tasks efficiently and securely relies on the concept of permissions. Permissions determine what actions and resources are accessible to different components within a system, ensuring the integrity, confidentiality, and availability of data and functionalities. By enforcing permissions, processors ensure that only authorized entities can perform specific operations or access sensitive data, protecting against unauthorized or malicious activities.

Processors typically support some manner of exceptions and/or interrupts that disrupt a currently executing program flow. Generally speaking, exceptions are related to events triggered by program execution while interrupts are triggered by circuits external to a processor core. When asserted, an exception may cause a processor to cease execution of currently active program threads and, instead, branch execution to an exception handler, e.g., a program routine included to identify and/or process events that lead to the exception being asserted. Exception vectors are reserved locations in memory in which an address is stored that points to a memory location where the exception handler instructions are located. Various processors may have any suitable number of exception vectors, each vector capable of storing a respective address of a corresponding exception handler. One or more exception signals may be associated with each exception vector. When a given exception signal is asserted, the associated exception vector is read, and the respective address is retrieved. This address is then used to fetch instructions of the corresponding exception handler.

### BRIEF DESCRIPTION OF THE DRAWINGS

FIG. 1 illustrates a block diagram of a first embodiment of a system that includes a processor circuit and a memory circuit.

FIG. 2 shows a block diagram of a second embodiment of a system that includes a processor circuit and a memory circuit.

FIG. 3 depicts a block diagram of a third embodiment of a system that includes a processor circuit and a memory circuit.

FIG. 4 illustrates a flow diagram of an embodiment of a method for identifying a particular exception vector using a determined processor mode.

FIG. 5 shows a flow diagram of an embodiment of a method for determining a particular processor mode to use to identify an exception vector table.

FIG. 6 depicts a flow diagram of another embodiment of a method for determining a particular processor mode to use to identify an exception vector table.

FIG. 7 illustrates a flow diagram of an embodiment of a method for using a privilege level to determine a particular processor mode to use to identify an exception vector table.

FIG. 8 is a block diagram of an embodiment of a device.

### DETAILED DESCRIPTION OF EMBODIMENTS

An application executing on a processor may contain code from many disparate origins, including shared libraries, malloc, dynamic linker/loader, application logic, user interface (UI) code. Such code may execute in some instances as separate threads of the application. For runtime-compiled or just-in-time (JIT) scenarios, code to be executed may come from the input code, the JIT compiler, the JIT validator, or the JIT output region. For a kernel of an operating system, this code may include memory management code, other kernel code, and kernel-mode drivers.

For reasons of security, it is desired to isolate or “sandbox” these disparate components by enforcing certain restrictions on their operation and interaction. For example, it may be desired that only malloc code should be able to read/write malloc metadata; only JIT validator code can write to the JIT output region; shared libraries can only read/write the heap regions of the software component that called them, etc.

A temporal identifier, referred to herein as an agent index, can also be used as a proxy for identifying what code (i.e., what software agent) is being executed. Accordingly, the source of a memory access may be qualified with both a spatial identifier (e.g., based on the current value of the program counter (PC) being executed) and a temporal identifier (e.g., the agent index). Permissions for a given region of virtual memory may thus be based not only on the location of the executing instructions, but also on the identity of the software agent.

As a temporal control, the value of the agent index (which may also be referred to as Tindex, or temporal index) may be changed from time to time as the software agent that is executing changes (e.g., because of a control flow instruction such as a call or return). This change may be effectuated in some implementations via execution of an agent transition instruction within the ISA of a processor circuit. Such instructions may be executed at different privilege levels of a processor circuit that is configured to execute instructions at a plurality of privilege levels.

One method of attack that malware may use to circumvent the security measures described above is by forcing exceptions via program execution. Exception handlers may be performed at more privileged levels, potentially allowing malware to gain access to privileged instructions and secure memory locations.

This disclosure describes techniques for maintaining multiple exception vector tables linked to exceptions signals and selecting, in response to assertion of a related exception signal, a particular one of the exception vector tables based on current operating parameters of a processor. A corresponding exception vector may then be retrieved based on the particular exception signal that is asserted.

Such techniques may include, in some embodiments, a mode transition circuit that selects a particular one of a plurality of processor modes (including current agent index values), and an exception management circuit that receives indications of asserted exception signals. If an exception signal is asserted, then the exception handler circuit may select one of a plurality of exception vector tables based on a determined processor mode and use the selected exception vector table to identify an address of a corresponding exception handler to fetch.

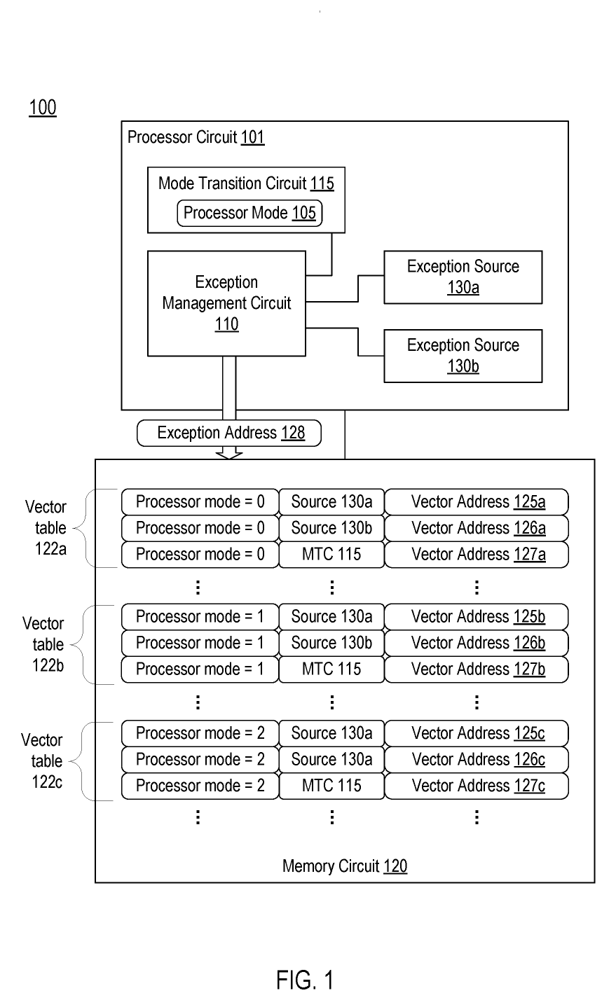

An example computer system is shown in FIG. 1. System 100 of FIG. 1 includes processor circuit 101 and memory circuit 120. Processor circuit 101 includes exception management circuit 110, mode transition circuit 115, and two exception sources 130a and 130b (collectively 130). Memory circuit 120 is configured to store a plurality of vector tables 122a-122c (collectively 122), each shown with three respective vector addresses 125-127. System 100 may be, in whole or in part, a computing system, such as a desktop or laptop computer, a smartphone, a tablet computer, a wearable smart device, or the like. In some embodiments, system 100 is a single IC, such as a system-on-chip, or a multi-die chip.

As illustrated, memory circuit 120 may be implemented using any suitable type of memory including volatile, non-volatile memory, and combinations thereof. Memory circuit 120 may include one or more memory management controllers and may include memory circuits, such as, static random-access memory (SRAM), as well as dynamic random-access memory (DRAM) and/or non-volatile memories such as flash memory. In some embodiments, memory circuit 120 may include interfaces for accessing separate DRAM and/or flash memory devices. As an example, memory circuit 120 may include SRAM, a first memory controller circuit for accessing DRAM, and a second memory controller for accessing flash memory. Program instructions and various types of data files may be stored in the flash data for long-term storage, such as when system 100 is powered-down. During a boot process, an operating system and one or more applications may be launched, including copying at least some of the instructions and related information into DRAM and/or SRAM for faster access by processor circuit 101.

Memory circuit 120 is configured to store a plurality of exception vector tables, including vector tables 122. Although presented as three individual tables, vector tables 122 may be implemented within a single data structure within memory circuit 120. For example, as a single table that is accessed via 3 or more indices (e.g., a 3-dimensional table) with at least some table entries located in adjacent memory addresses. In some embodiments, vector tables 122 may be stored within a particular address range of memory circuit 120, with a subset of table entries from different ones of vector tables 122 interleaved within the particular address range.

As shown, mode transition circuit 115 is configured to select a particular one of a plurality of processor modes, wherein a given processor mode of the plurality of processor modes corresponds to a respective set of memory access permissions. For example, the selected processor mode, such as processor mode 105, may be associated with a particular agent index value, used to determine memory access permissions for an active software agent indicated by the particular agent index value.

Processor circuit 101 includes plurality of circuits (e.g., exception sources 130) that are configured to assert respective exception signals. Exception sources 130 may, for example, include circuits configured to assert an exception signal in response to decoding an illegal instruction and/or in response to detecting a memory access to an unimplemented or restricted memory address. In some embodiments, mode transition circuit 115 may be configured to assert a respective exception signal in response to execution of an instruction to transition from a first processor mode to a second. Mode transition circuit 115 may assert one exception signal in response to an allowed processor mode transition and assert a different exception signal in response to an attempt to make an unauthorized processor mode transition.

As illustrated, exception management circuit 110 is configured to receive an indication of an assertion of a particular exception signal by a respective one of exception sources 130 or mode transition circuit 115. For example, mode transition circuit 115 may be configured to assert the particular exception signal based on execution of a mode change instruction that requests a mode change from a current processor mode to a requested processor mode.

After a determination that a particular exception signal has been asserted, exception management circuit 110 is further configured to select one of vector tables 122 based on a determined processor mode. In some cases, the determined processor mode may correspond to current processor mode 105, while in other cases the determined processor mode may be different from processor mode 105. For example, exception management circuit 110 may be further configured to, based on a mode change from the processor mode 105 to a requested processor mode being allowed, determine the vector address based on the requested processor mode. Moreover, based on the mode change from processor mode 105 to the requested processor mode being denied, exception management circuit 110 may determine the vector address based on processor mode 105.

After one of vector tables 122 has been selected (e.g., vector table 122b), exception management circuit 110 may be further configured to, based on the particular exception signal, determine a vector address within the selected one of vector tables 122. For example, the determined processor mode may be “processor mode 1” thereby causing exception management circuit 110 to select vector table 122b. If mode transition circuit 115 asserted the particular exception signal, then corresponding vector address 127b may be retrieved from memory circuit 120.

Exception management circuit 110 may be further configured to retrieve a particular exception handler address that is stored at vector address 127b. An instruction fetch operation may then be initiated based on the exception handler address, and one or more instructions included in a corresponding exception handler may be fetched from other locations in memory circuit 120.

If, instead of processor mode 1, the determined processor mode is processor mode 0 or processor mode 2, then exception management circuit 110 may select vector table 122a or vector table 122c, respectively. Based on mode transition circuit 115 asserting the particular exception signal, then corresponding vector address 127a or 127c may be retrieved from memory circuit 120. Accordingly, based on the determined processor mode, one of three different exception handlers may be fetched and used to service event that caused the particular exception signal to be asserted.

Use of such a technique for selecting a particular vector table based on a determined processor mode may provide additional security to prevent an unauthorized access to restricted memory and/or a malware takeover of system 100. If a determined processor mode is indicative of a software agent that is associated with other active software agents, then the selected vector table may point to exception handlers that allow integration between the different software agents. In contrast, if a determined processor mode is indicative of a software agent that is not associated with other active software agents, then the selected vector table may point to exception handlers that isolates the indicated software agent from other software agents, thereby increasing an ability of system 100 to thwart malware attacks.

It is noted that system 100, as illustrated in FIG. 1, is merely an example. The illustration of FIG. 1 has been simplified to highlight features relevant to this disclosure. Various embodiments may include different configurations of the circuit elements. For example, processor circuit 101 may include various other elements, such as an execution pipeline, instruction and/or data caches, branch prediction circuits, memory management units, and the like. In various embodiments, circuits of system 100 may be implemented using any suitable combination of sequential and combinatorial logic circuits. In addition, register and/or memory circuits, such as SRAM, may be used in these circuits to temporarily hold information such as instructions, data, address values, and the like.

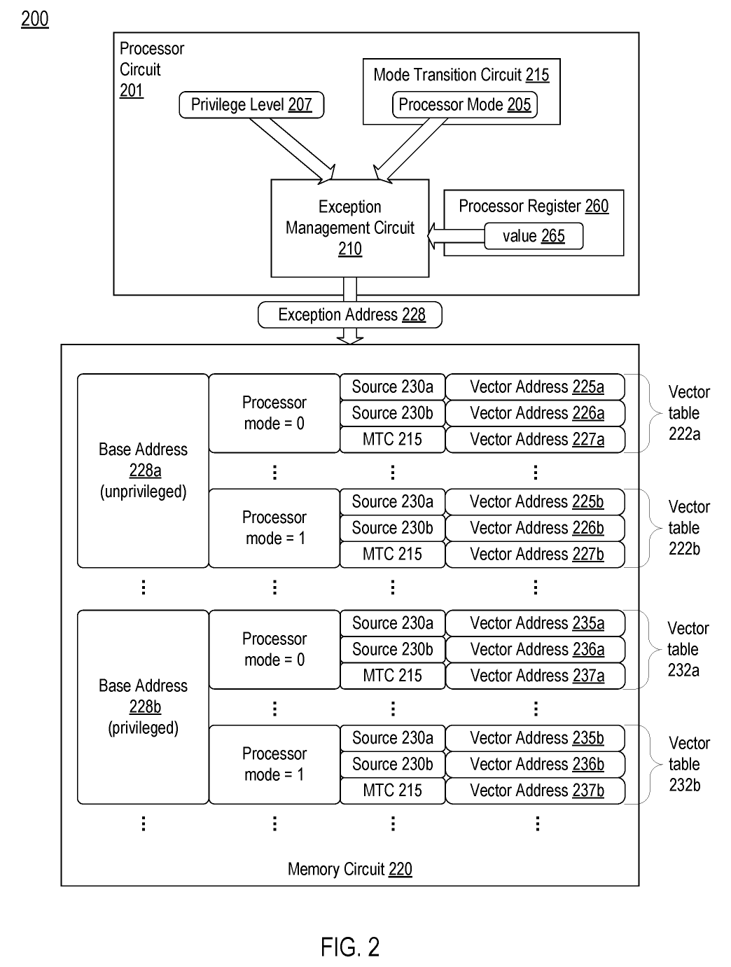

The techniques described in regard to FIG. 1 include selection of one of a plurality of vector tables based on a processor mode. In other embodiments, other factors may be used to select the one vector table. One such example is depicted in FIG. 2.

Moving to FIG. 2, another embodiment of a system with a processor circuit that supports multiple vector tables is shown. In a similar manner as system 100, system 200 includes processor circuit 201 and memory circuit 220. Elements of FIG. 2 that are similarly named and numbered to elements of FIG. 1 perform functions as described above, with exceptions described below. Processor circuit 201 includes processor register 260 that is capable of storing value 265, as well as an indicator for privilege level 207. Memory circuit 220 includes a plurality of vector tables including vector tables 222a, 222b, 232a, and 232b.

As shown, processor circuit 201 is configured to execute instructions using one of a plurality of privilege levels. As described above, a given privilege level may be associated with a particular set of instructions and memory access privileges. Exception management circuit 210 may be configured to determine a vector address based on a particular privilege level in addition to a determined processor mode and a particular exception signal. To determine the vector address, the exception management circuit is further configured to use a first base vector address based on a determination the particular privilege level is unprivileged, and to use a second base vector address, different from the first base vector address, based on a determination the particular privilege level is more privileged. For example, memory circuit 220 includes vector tables 222a and 222b that are associated with base address 228a and a different set of vector tables 232a and 232b that are associated with base address 228b. In some embodiments, base address 228a may correspond to the first privilege level while base address 228b corresponds to the second privilege level.

In some cases, the particular privilege level may correspond to a particular privilege level when the particular exception signal is asserted. For example, privilege level 207 may be unprivileged when the particular exception signal is asserted. In response to the assertion, privilege level 207 may be increased to a more privileged level to enable an associated exception handler to have access to additional instructions and/or memory access permissions. In some cases, however, it may be desired to select the exception vector and subsequent exception handler based on the unprivileged level that was active when the particular exception signal was asserted rather than the current privileged level when the exception vector is being selected. Accordingly, base address 228a may be used to choose one of vector tables 222 corresponding to the unprivileged level.

After base address 228a is determined, exception management circuit 210 may then use the determined processor mode to select between vector tables 222a and 222b. A source for the particular exception signal (e.g., mode transition circuit 215, source 230a or source 230b) may then be used to select one of vector addresses 225-227 from the selected one of vector tables 222. If base address 228b were selected rather than base address 228a, then exception management circuit 210 may use the determined processor mode to select between vector tables 232a and 232b. The source for the particular exception signal may then be used to select one of vector addresses 235-237 from the selected one of vector tables 232.

In some embodiments, the particular exception signal may be associated with a change from a first privilege level to a second privilege level. Such a change in privilege level may be from a more privileged level to a less privileged level, or vice versa. For example, program instructions may be used to transition from an unprivileged level to a privileged level in order to perform a system configuration or other task that requires instructions that are unavailable at the unprivileged level. A corresponding exception signal may be asserted in response to this change in privilege level. In such a case, exception management circuit 210 may be configured to determine the vector address based on a particular processor mode associated with the unprivileged level that was active when the change to the more privileged level was initiated.

In some embodiments, use of multiple vector tables may be enabled and disabled based on value 265 in processor register 260. As shown, exception management circuit 210 is further configured to determine the vector address based on the determined processor mode and the particular exception signal if a first value is stored in processor register 260, and determine the vector address based on the particular exception signal when a second value is stored in processor register 260. Value 265 may include one or more data bits used to determine whether multiple vector tables are to be used. In some embodiments, value 265 may be written in more privileged levels only, thereby preventing access to programs executing at the unprivileged level. For example, a first operating system may not support multiple vector tables, and therefore would be capable of disabling this feature, while a second operating system would be capable of enabling the feature to, for instance, increase a level of security fir exception handling.

It is noted that the embodiment of FIG. 2 is one example used for demonstrative purpose. Although two base addresses, each including two vector tables are shown, it is contemplated that any suitable number of base addresses may be used, each including a respective number of vector tables.

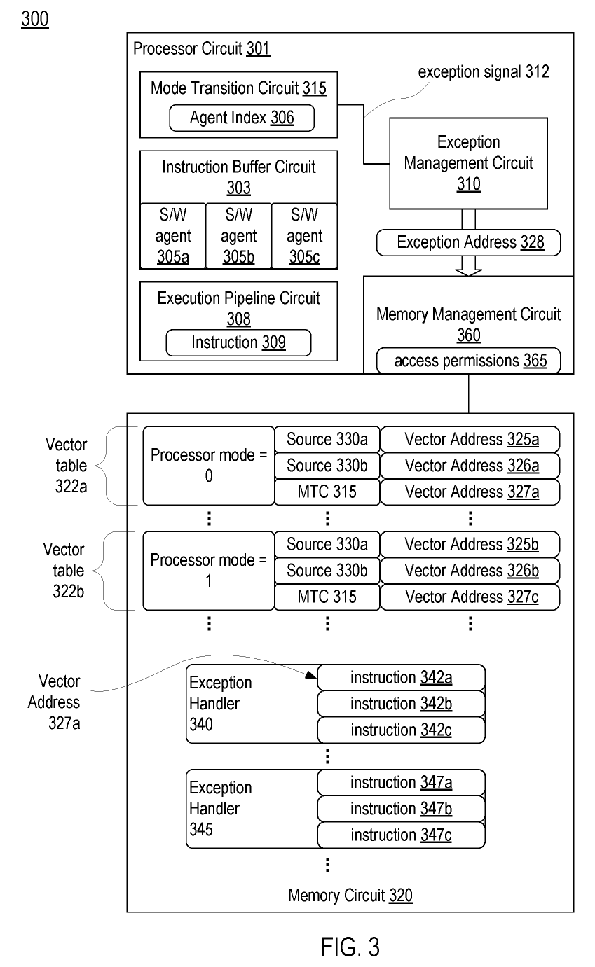

The embodiments disclosed in regard to FIGS. 1 and 2 have described systems in which a processor mode and a privilege level are used to select a particular vector table and subsequently a particular vector address. Some details are omitted to focus on the disclosed features. In FIG. 3, some additional details are presented to describe how the disclosed techniques are implemented.

Turning to FIG. 3, a third embodiment of a system with a processor circuit that supports multiple vector tables is shown. In a similar manner as systems 100 and 200, system 300 includes processor circuit 301 and memory circuit 320. Except as noted below, elements of FIG. 3 that are similarly named and numbered to elements of FIGS. 1 and 2 may perform functions as described above. In addition to elements described above, processor circuit 301 includes instruction buffer circuit 303 that stores instructions for software (S/W) agents 305a-305c (collectively 305), as well as execution pipeline circuit 308. Processor circuit 301 further includes memory management circuit 360. Memory circuit 320 includes vector tables 322a and 322b, as well as exception handlers 340 and 345, each with a plurality of instructions 342 and 347, respectively.

As illustrated, processor circuit 301 includes a memory management circuit 360 that may be configured to perform memory accesses based on memory access permissions 365 corresponding to agent index 306. For example, memory circuit 320 may include a non-transitory, computer-readable storage medium storing program instructions that are executable by execution pipeline circuit 308. These stored program instructions include respective sets of instructions for software agents 305. Each of software agents 305 may correspond to a respective application, applet, software driver, and the like. In some cases, one or more of software agents 305 may be associated, such as different programs within a common software suite. Other ones of software agents 305 may be independent of other programs that may be running concurrently.

The computer-readable storage medium may store one or more instances of instruction 309 that is executable by processor circuit 301 to request an agent transition. For example, execution of instruction 309 may initiate a change from a current value of agent index 306 to a new value. A value of agent index 306 may be indicative of one of software agents 305 that is currently executing on the processor circuit. At various points in time, execution pipeline circuit 308 may switch contexts, pausing execution of one software agent (e.g., software agent 305b) to start or restart execution of a different software agent (e.g., software agent 305c). Execution pipeline circuit 308 may switch context for a variety of reasons, such as a long-lead memory access is made by software agent 305b that would otherwise leave execution pipeline circuit 308 idle. A context switch may also be triggered by user input, e.g., changing focus from a first program associated with software agent 305b to a second program associated with software agent 305c.

As shown, execution of an instance of instruction 309 causes processor circuit 301 to assert exception signal 312 of a plurality of exception signals. This assertion of exception signal 312 may cause processor circuit 301 to change from an unprivileged level to a more privileged level. Processor circuit 301 may, based on a value of agent index 306, determine one vector table of vector tables 322 to access. In some embodiments, the execution of instruction 309 may further cause processor circuit 301 to determine which of vector tables 322 to access based on a particular value of agent index 306 that is associated with the unprivileged level.

In particular embodiments, processor circuit 301 may determine whether the requested agent transition is permitted. Based on the requested agent transition being allowed, processor circuit 301 may determine which of vector tables 322 to access based on the new value of agent index 306. If, however, the requested agent transition is denied, then processor circuit 301 may determine which of vector tables 322 to access based on a current value of agent index 306. For example, agent transitions between software agent 305a and 305b or 305a and 305c may be allowed, but transitions between 305b and 305c may be denied.

In some embodiments, execution of instruction 309 may further cause processor circuit 301 to, while currently operating at a more privileged level, use an unprivileged level to determine which of the plurality of vector tables to access. For example, processor circuit 301 may use a value of agent index 306 that is associated with the unprivileged level to determine a base vector address, and then use this base vector address to select the one vector table.

After the one vector table has been selected from vector tables 322, processor circuit 301 may access one of vector addresses 325-327 from the one vector table based on a source of the assertion of exception signal 312 (e.g., mode transition circuit 315, source 330a or source 330b). For example, if vector table 322a is selected, then vector address 327a may be accessed based on exception signal 312 being associated with mode transition circuit 315. Processor circuit 301, via exception circuit 310, determine that exception address 328 is the location of the exception vector to be retrieved. Vector address 327a may then be retrieved, by memory management circuit 360 from vector table 322a, thereby enabling a first instruction (e.g., instruction 342a) located at vector address 327c to be fetched. For example, memory management circuit 360 may receive a memory access request from exception management circuit 310 to access instruction 342a as indicated by vector address 327c. In some embodiments, memory management circuit 360 may, based on the request coming from exception management circuit 310, fetch instruction 342a without using the given set of memory access permissions 365.

In a similar manner as described above, use of multiple vector tables may be enabled and disabled based on a value in a processor register, e.g., value 265 in processor register 260 as shown in FIG. 2. For example, the execution of the particular instance of instruction 309 further causes processor circuit 301 to determine whether to use the value of agent index 306 to select the one vector table, based on value 265 stored in processor register 260. Use of multiple vector tables may, therefore, be a programmable option.

It is noted that that the system of FIG. 3 is merely an example. Although two vector tables are shown, any suitable number of vector tables may be used. Likewise, more than the two illustrated exception handlers may be included in other embodiments.

To summarize, various embodiments of a processor circuit may include a mode transition circuit, a plurality of circuits, and an exception management circuit. The mode transition circuit may be configured to select a particular one of a plurality of processor modes. A given processor mode of the plurality of processor modes may correspond to a respective set of memory access permissions. The plurality of circuits, including the mode transition circuit, may be configured to assert respective exception signals. The exception management circuit may be configured to receive an indication of an assertion of a particular exception signal by a respective one of the plurality of circuits, and then select a vector table of a plurality of vector tables based on a determined processor mode of the plurality of processor modes. The exception management circuit may also be configured to, based on the particular exception signal, determine a vector address within the selected vector table and, based on the determined vector address, retrieve a particular exception handler address from the selected vector table.

In a further example, the mode transition circuit may be further configured to assert the particular exception signal based on execution of a mode change instruction that requests a mode change from a current processor mode to a requested processor mode. In an example, the exception management circuit may be further configured to, based on the mode change from the current processor mode to the requested processor mode being allowed, determine the vector address based on the requested processor mode. The exception management circuit may also be configured to, based on the mode change from the current processor mode to the requested processor mode being denied, determine the vector address based on the current processor mode.

In another example, the exception management circuit may be further configured to determine the vector address based on a particular privilege level in addition to the determined processor mode and the particular exception signal. The particular privilege level may correspond to a selected privilege level when the particular exception signal is asserted. In one example, to determine the vector address, the exception management circuit may be further configured to use a first base vector address based on a determination the particular privilege level is unprivileged, and to use a second base vector address, different from the first base vector address, based on a determination the particular privilege level is more privileged.

In a further embodiment, the particular exception signal may be associated with a change from a first privilege level to a second privilege level, more privileged than the first privilege level. The exception management circuit may be further configured to determine the vector address based on a particular processor mode associated with the first privilege level. In an example, the exception management circuit may be further configured to determine the vector address based on the determined processor mode and the particular exception signal, based on a determination that a first value is stored in a particular processor register. The exception management circuit may also be configured to determine the vector address based on the particular exception signal, based on a determination that a second value is stored in the particular processor register.

In another example, the processor circuit may further include a memory management unit that, in turn, may be configured to perform memory accesses based on a given set of memory access permissions corresponding to a given processor mode. The memory management unit may also be configured to access, without using the given set of memory access permissions, a first instruction that is indicated by the particular exception handler address.

In an example, the apparatus may further comprise a memory circuit. The plurality of vector tables may be stored within a particular address range of the memory circuit. A subset of table entries from different vector tables of the plurality of vector tables may be interleaved within the particular address range.

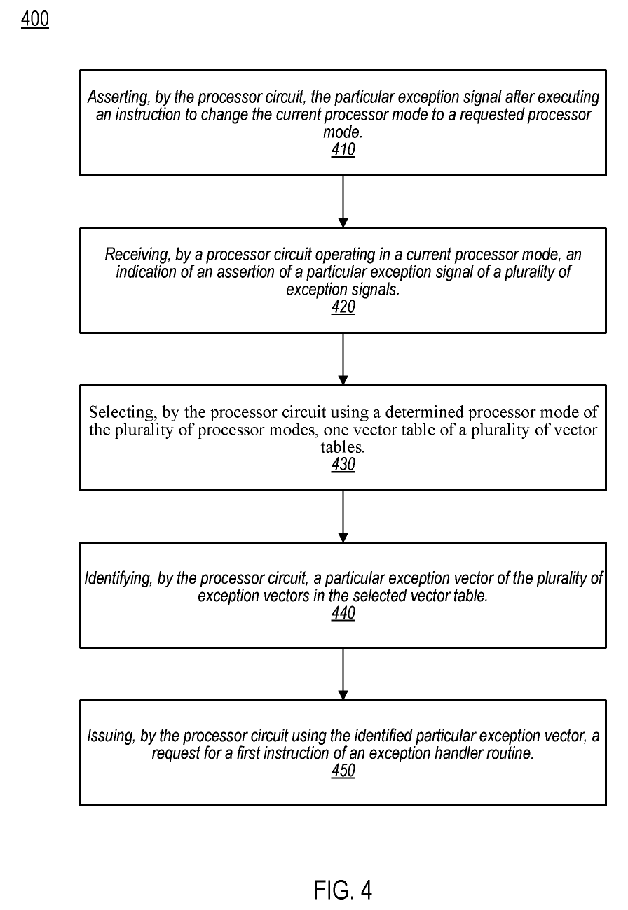

Proceeding to FIG. 4, a flow diagram of one embodiment of a method for identifying a particular exception vector using a determined one of a plurality of processor modes is illustrated. Method 400 is written from the perspective of a processor circuit, such as processor circuits 101, 201, and 301 as shown in FIGS. 1-3. Exemplary reference numerals from FIG. 1 are provided for convenience in the following description of method 400. Such reference numerals, however, are not intended to unduly limit the scope of this method.

Method 400 begins at block 410 by a processor circuit, operating in a current processor mode, asserting a particular exception signal of a plurality of exception signals after executing an instruction to change a current processor mode to a requested processor mode. For example, processor circuit 101 may be operating in a current one of a plurality of processor modes, wherein the current processor mode indicates a particular set of memory access permissions to be used when a memory access request is processed. Processor circuit 101 may include a plurality of circuits that are capable of asserting respective exception signals in response to an occurrence of a particular event or set of conditions. One such circuit and event may include an execution pipeline circuit receiving and decoding the instruction to change the current processor mode.

At block 420, method 400 continues by the processor circuit receiving an indication of the assertion of the particular exception signal. The particular exception signal may be mapped to a plurality of exception vectors. Exception management circuit 110, within processor circuit 101, may look for an exception vector that corresponds to the particular exception signal. Processor circuit 101 is configured to support a plurality of vector tables, such that exception management circuit 110 determines which vector table to use to retrieve the corresponding exception vector.

Method 400 continues at block 430 by the processor circuit, using a determined processor mode of the plurality of processor modes, selecting one vector table of the plurality of vector tables. As shown in FIG. 1, memory circuit 120 stores three different vector tables 122. Each of the three vector tables 122 is associated with a respective processor mode. Accordingly, processor circuit 101 (e.g., via exception management circuit 110) selects the one vector table based on the determined processor mode. As previously described, the determined processor mode may differ from a current processor mode. For example, when the particular exception signal is asserted, a privilege level may be changed in processor circuit 101, thereby resulting in a different processor mode being selected as the current processor mode. Processor circuit 101 may use a processor mode associated with the prior privilege level as the determined processor mode and use this determined processor mode to select the one vector table.

At block 440, method 400 proceeds with the processor circuit identifying a particular exception vector of a plurality of exception vectors in the selected vector table. After the one vector table is selected, a particular one exception vector may be identified from a plurality of exception vectors included in the one vector table. As shown in FIG. 1, each vector table 122 is depicted as having at least three corresponding exception vectors, each corresponding exception vector associated with a particular exception source. Accordingly, processor circuit 101 may select the particular exception vector based on the exception source associated with the particular exception signal.

Method 400 continues at block 450 with the processor circuit issuing, using the identified particular exception vector, a request for a first instruction of an exception handler routine. For example, the particular exception vector corresponds to a particular exception address 128 that points to a location in memory circuit 120, e.g., vector address 127a in vector table 122a. In turn, vector address 127b points to another address in memory circuit 120 where a first instruction of an associated exception handler routine is stored. At least the first instruction, and possibly more instructions, may then be fetched for execution by processor circuit 101. Execution of the exception handler may identify a cause and/or perform a particular task that is related to the event that triggered the particular exception signal. At the end of the exception handler, processor circuit 101 may return to a program mode and privilege level that were selected prior to the assertion of the particular exception signal and program flow may return a software agent that was active at that point in time.

It is noted that the method of FIG. 4 includes blocks 410-450. Method 400 may end in block 450 or may repeat some or all blocks of the method. For example, method 400 may repeat in response to an assertion of another exception signal. Method 400 may be performed concurrently with a different instance of method 400. In some embodiments, for example, a second exception signal may be asserted while method 400 is being performed to service a first exception signal. In multicore processor embodiments, respective instances of method 400 may be performed concurrently by different cores.

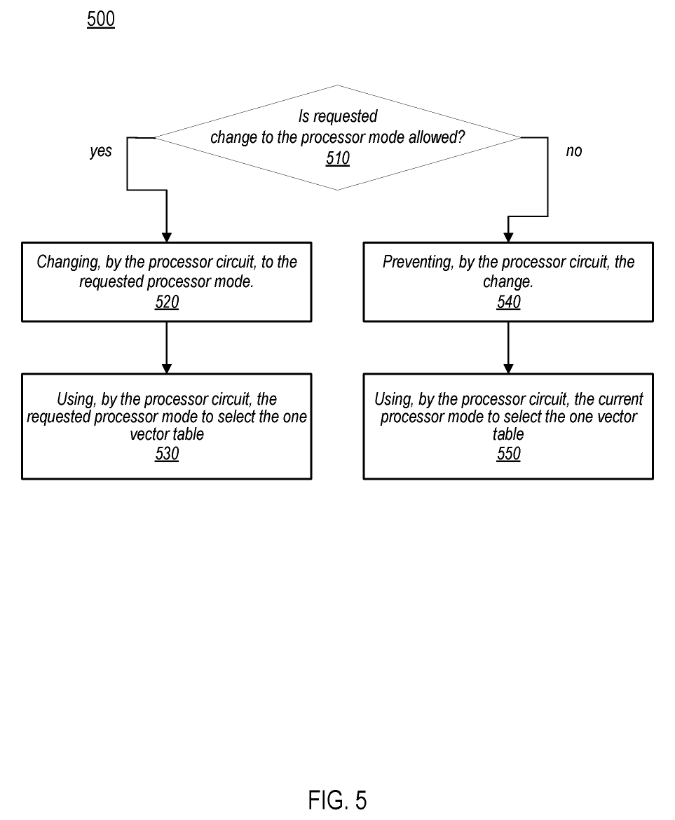

Proceeding to FIG. 5, a flow diagram of an embodiment of a method for determining a particular one of a plurality of processor modes for selecting a corresponding vector table is shown. In a similar manner as method 400, method 500 may be performed by a processor circuit, such as any of processor circuits 101, 201, and 301 in FIGS. 1-3. Method 500 is described below using processor circuit 101 of FIG. 1 as an example. References to elements in FIG. 1 are included as non-limiting examples. In some embodiments, method 500 may be performed as a part of block 430 of method 400. Method 500 begins after processor circuit 101 has received an indication of an assertion of a particular exception signal that is associated with a request to change processor modes.

Method 500 may begin at block 510 by determining whether the requested change from a first processor mode to a second processor mode is allowed. For example, a particular instruction may be fetched and decoded by processor circuit 101, the particular instruction requesting the change from the first processor mode to the second processor mode. In various embodiments, the decoding or execution of the particular instruction may cause the particular exception signal to be asserted. Continuation of method 500 may depend on determining whether the requested mode change is permissible. If the requested mode change is allowed, then method 500 moves to block 520 to change the mode. Otherwise, method 500 jumps to block 540 to prevent the mode change.

Method 500 may continue at block 520 with the processor circuit changing to the requested processor mode. Processor circuit 101 (e.g., via mode transition circuit 115) may update one or more system registers to implement the change to the second processor mode. A value of processor mode 105 may be updated to indicate the new processor mode.

At block 530, method 500 proceeds by the processor circuit using the requested processor mode to select the one vector table. For example, the second (new) processor mode may be processor mode 2. As shown in FIG. 1, processor mode 2 is associated with vector table 122c. Accordingly, processor circuit 101 may select vector table 122c as the one vector table after the change to processor mode 2 has been allowed.

If, in block 510, the requested change to the processor mode is denied, method 500 continues at block 540 with the processor circuit preventing the change to the second processor mode. For example, mode transitions between processor modes 0 and 1 and between processor modes 0 and 2 may be allowed, but transitions between processor modes 1 and 2 may be denied. In such an embodiment, if the first processor mode is processor mode 1 and the second is processor mode 2, then the requested transition may be denied.

At block 550, method 500 proceeds with the processor circuit using the current processor mode to select the one vector table. For example, the first (current) processor mode may be processor mode 0. As shown in FIG. 1 processor mode 0 is associated with vector table 122a. Processor circuit 101 may, therefore, select vector table 122a as the one vector table after the change to processor mode 2 has been denied and processor circuit 101 remains in the current processor mode 0.

It is noted that method 500 includes blocks 510-550. In various embodiments, method 500 may end in block 530 or 550, depending on allowance of the requested processor mode change. Method 500, similar to method 400, may be performed concurrently with a different instance of methods 400 and/or 500. As described above, a second exception signal may be asserted while method 500 is being performed to service a first exception signal. In multicore processor embodiments, for example, respective instances of methods 400 and 500 may be performed concurrently by different cores.

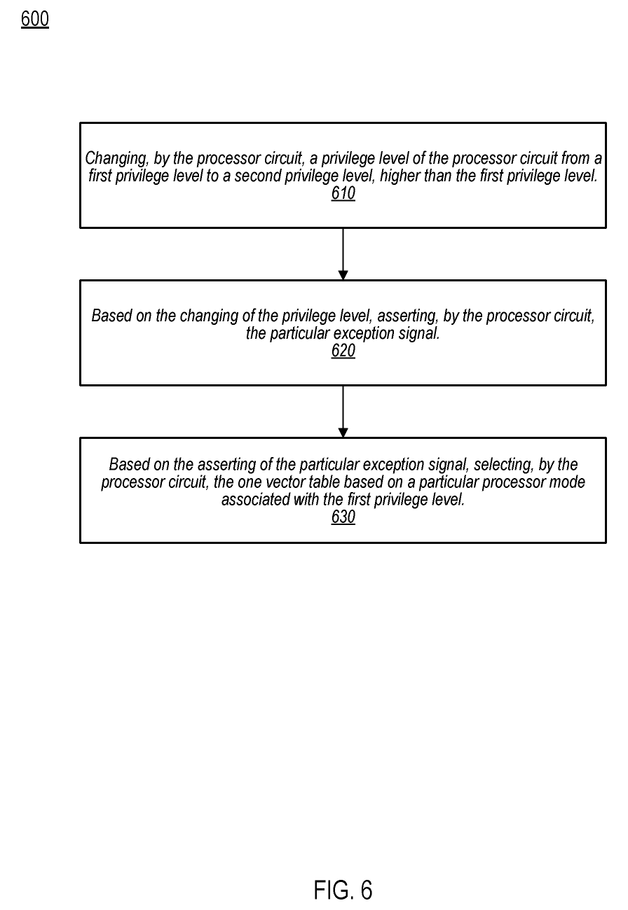

Moving now to FIG. 6, a flow diagram for an embodiment of a method for selecting a vector table using a processor privilege level is depicted. Similar to methods 400 and 500, method 600 may be performed by a processor circuit, such as processor circuits 101, 201, and 301 in FIGS. 1-3. Method 600 is described below using processor circuit 201 of FIG. 2 as an example. References to elements in FIG. 2 are included as non-limiting examples.

At block 610, method 600 begins with a processor circuit changing a privilege level of the processor circuit from a first privilege level to a second privilege level, the second privilege level being more privileged than the first privilege level. As described above, a given privilege level may be associated with a particular set of instructions and memory access privileges. The privilege level may be changed for a variety of reasons including, for example, a switch in program context from an application running at an unprivileged level to an operating system or a system process that utilizes one or more instructions of an extended set of instructions and/or memory access permissions that are not available in the unprivileged level.

Method 600 continues at block 620 by, based on the changing of the privilege level, the processor circuit asserting a particular exception signal. In some embodiments, a change in privilege level may cause a respective exception signal to be asserted. For example, a particular exception handler may be executed to manage the transition between privilege levels and/or to determine whether the transition to the second privilege level is secure.

At block 630, method 600 proceeds by, based on the asserting of the particular exception signal, the processor circuit selecting the one vector table based on a particular processor mode associated with the first privilege level. For example, processor circuit 201 (e.g., using exception management circuit 210) may determine a vector address based on the first privilege level in addition to the determined processor mode and a source of particular exception signal. Processor circuit 201 may determine the vector address using base address 228a based on determining that the first privilege level is unprivileged, and using base address 228b based on determining that the first privilege level is more privileged.

It is noted that method 600 may end in block 630. In some embodiments, method 600 may include additional operations and/or may perform operations of a different method. For example, processor circuit 201 may, after a base vector address has been determined, perform one or more operations similar to operations 430-450 of method 400 to identify a corresponding vector address. This vector address may then be used to fetch one or more instructions included in an exception handler that is related to the change in privilege level.

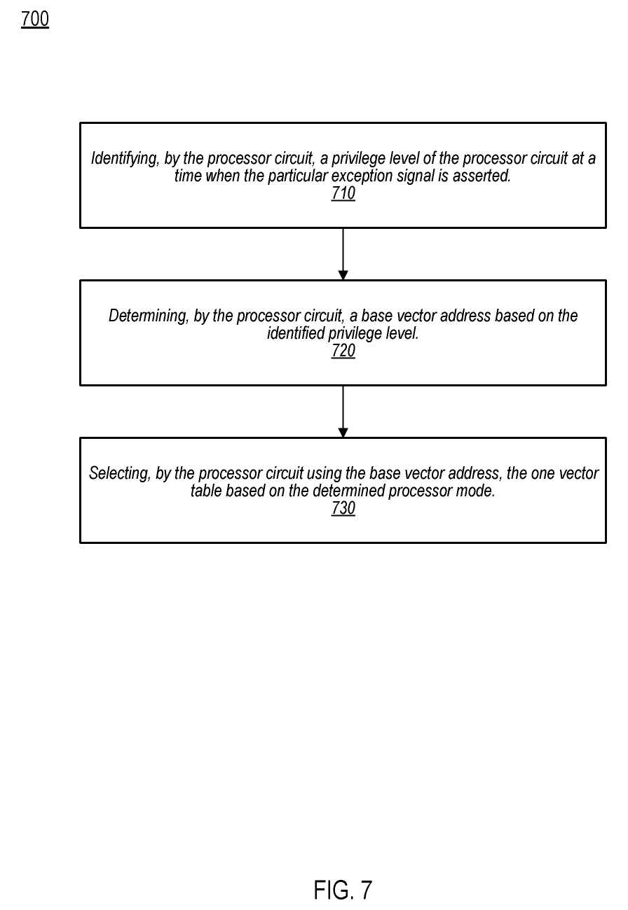

Turning now to FIG. 7, a flow diagram for another embodiment of a method for selecting a vector table using a processor privilege level is shown. Similar to methods 400-600, method 700 may be performed by a processor circuit, such as processor circuits 101, 201, and 301 in FIGS. 1-3. Similar to method 600, method 700 is described below using processor circuit 201 of FIG. 2 as an example. References to elements in FIG. 2 are included as non-limiting examples. Method 700 begins after a particular exception signal has been asserted.

At block 710, method 700 begins with a processor circuit identifying a privilege level of the processor circuit at a time when the particular exception signal is asserted. For example, privilege level 207 may indicate a current privilege level of processor circuit 201. When the particular exception signal is asserted, privilege level 207 may indicate an unprivileged level. In response to the assertion of the particular exception signal, privilege level 207 may be increased to a more privileged level to enable an associated exception handler to have access to additional instructions and/or memory access permissions.

Method 700 continues at block 720 by the processor circuit determining a base vector address based on the identified privilege level. For various reasons, it may be desired to select the exception vector and subsequent exception handler based on the unprivileged level that was active when the particular exception signal was asserted rather than the current privileged level when the exception vector is being selected. Accordingly, processor 201 may determine a base vector address associated with the unprivileged level (e.g., base address 228a).

Method 700 proceeds at block 730 by the processor circuit selecting, using the base vector address, the one vector table based on the determined processor mode. After the base vector address has been determined as base address 228a, processor circuit 201 may use a determined processor mode to select a corresponding vector table from one of vector tables 222a and 222b that are associated with base address 228a. As shown in FIG. 2, vector table 222a is associated with processor mode 0 while vector table 222b is associated with processor mode 1. The determined processor mode may differ from current processor mode 205. For example, processor mode 205 may change when the privilege level transitions from unprivileged to more privileged. If the unprivileged level is used to select base address 228a, then a privilege level associated with the unprivileged level may be determined rather than using the current processor mode 205. Using the determined processor mode, one of vector tables 222 is selected and a vector address that corresponds to the particular exception signal may be identified and used to fetch instructions of the associated exception handler.

It is noted that the method of FIG. 7 includes operations 710-730. In a similar manner as described above, performance of various operations of methods 400-700 may be performed concurrently and/or in an interleaved fashion. For example, in a multicore processor, a plurality of exception signals may be asserted concurrently, with different ones of the cores performing one or more of methods 400-700 in response to the assertions.

### Example Device

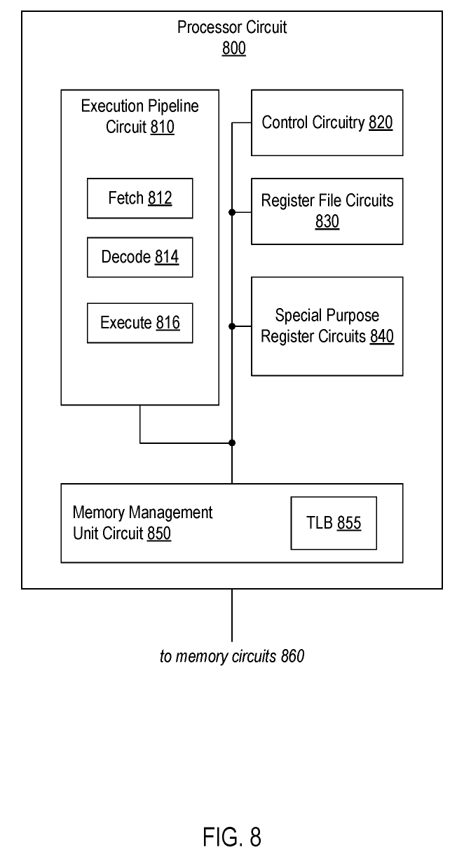

Referring now to FIG. 8, a block diagram of one embodiment of a processor circuit that may be implemented on one or more integrated circuits (ICs) is shown. As depicted, processor circuit 800 includes execution pipeline circuit 810, control circuitry 820, register file circuit 830, special purpose register circuits 840, and memory management unit (MMU) circuit 850. As illustrated, processor circuit 800 is configured to perform instructions included in any suitable instruction set architecture (ISA). For example, processor circuit 800 may be configured to perform instructions included in ARM’s ArmV9 ISA, including instruction 309 of FIG. 3. Processor circuit 800 may represent one possible implementation of previously described processor circuits 101, 201, and 301 in FIGS. 1-3.

Execution pipeline circuit 810 is representative of circuitry within processor circuit 800 designed to retrieve instructions from memory, and then decode and execute them. Execution pipeline circuit 810 may include any number of stages, but only three exemplary stages are illustrated in FIG. 8. Fetch stage circuit 812, in one embodiment, is configured to issue memory requests to retrieve instructions and operand data via memory management circuit 850. In some embodiments, fetch stage circuit 812 may include pre-fetch circuitry to issue memory requests based on predicted next-fetch addresses. Instructions received via the issued memory requests may be stored in an instruction cache (not pictured) within processor circuit 800. Decode stage circuit 814, in one embodiment, is configured to parse instructions received by fetch stage circuit 812 in order to perform decode operations that prepare the instructions to be processed by execute stage circuit 816. For example, decode stage circuit 814 may be configured to determine from a retrieved instruction: a type of the instruction, a number of its operands, and whether data corresponding to the operands is currently available within processor circuit 800. Decode stage circuit 814 may be configured to place decoded, ready-to-execute instructions in an instruction buffer (not shown) for access by execute stage circuit 816. Execute stage circuit 816, in one embodiment, may retrieve a ready-to-execute instruction from an instruction buffer and perform the instruction using any associated operands. “Performing” the instructions may constitute different actions depending on the type of instruction. Some execution unit circuits within execute stage circuit might be able to complete the instructions, such as in the case of a register operation. Other execution units might initiate execution of an instruction, such as a load-store instruction in which a portion of the memory hierarchy is accessed. Operands of the instruction that reference memory locations may thus be loaded as part of execution by a load-store execution unit circuit and stored in a data cache (not pictured).

In various embodiments, execute stage circuit 816 may perform instructions in a same order as the instructions were fetched (e.g., in-order processing) or may be capable of changing an order of the instructions to improve processor efficiency (e.g., out-of-order processing). Although execute stage circuit 816 is shown as a single block, in some embodiments, execute 816 may include a plurality of execution units, such as an integer/Boolean unit, a floating-point unit, a load-store unit, and the like. Execution pipeline circuit 810 may be configured to process one program thread at a time or multiple threads in an overlapping (e.g., time-sliced) manner.

Control circuitry 820 is configured to perform various processor control operations related to execution of instructions using execution pipeline circuitry 810. These control operations include exception handling, context switches, packet transmission, etc. For example, control circuitry 820 may be configured to generate an exception based on a variety of inputs (such as an agent transition not being allowed).

Register file circuits 830 includes a set of registers that may be used to store operands for various instructions of pipeline 810. Such registers are commonly called “general purpose registers,” or GPRs. Register file circuits 830 may include registers of various data types, based on the type of operand execution pipeline 810 is configured to store in the registers (e.g., integer, floating point, multimedia, vector, etc.). Register file circuits 830 may directly implement architectural registers or may implement rename circuitry to map architectural registers to physical registers.

Special purpose register circuits 840 are registers within processor circuit 800 that are configured to store specific types of values. These register circuits 840 stand in contrast to registers of register file circuits 830, which may be used by any instruction executing on processor 800. Thus, processor register 260 may be implemented as part special purpose register circuits 840, as it is used for the specific purpose of storing a value used to enable and disable use of multiple vector tables. Other examples of special purpose register circuits 840 include the program counter (PC), instruction register (IR), stack pointer (SP), status register (flags register), and various other control registers.

MMU circuit 850 is configured to act as an interface between processor circuit 800 and memory located on memory circuit 860. For example, MMU circuit 850 may issue memory requests to a memory hierarchy that includes memory circuit 860. In one embodiment, MMU circuit 850 is coupled to a memory bus interface to perform read and write operations with memory circuit 860, including retrieving instructions and other information and storing information related to execution of program threads performed by execution pipeline circuit 810.

Furthermore, memory management circuit 850 may receive memory requests from execute stage circuit 816 (e.g., from a load-store unit circuit) and fetch stage circuit 812. In some embodiments, MMU circuit 850 may be coupled to a plurality of execution pipeline circuits, such as may be included in a core complex. Note that additional memory (not pictured) may be located on processor circuit 800. In some embodiments, MMU circuit 850 is configured to receive memory requests that specify virtual addresses. In such embodiments, MMU circuit 850 may be configured to use translation lookaside buffer (TLB) 855 to cache translation information to translate a received virtual address into a physical address corresponding to a particular location in memory circuit 860. Notably, MMU circuit 850 may also be configured to evaluate and enforce permissions related to various instructions in pipeline 810, for example, based on a value of one or more of special purpose registers 840. In one example implementation, MMU circuit 850 may deny a particular memory request if corresponding permissions are not enabled for a received virtual address specified by a memory-accessing instruction.

Memory circuit 860 includes one or more memory circuits within a system memory coupled to processor circuit 800. Although illustrated as a single block, memory circuit 860 may include a plurality of memory blocks. Such blocks may include various types of memory including, but not limited to, dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, memory circuit 860 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with an SoC or an integrated circuit in a chip-on-chip configuration, a package-on-package configuration, or a multi-chip module configuration.

In some embodiments, the elements of processor circuit 800 shown in FIG. 8 may constitute a single processor core. In other embodiments, the depicted elements constitute one of multiple processor cores within processor circuit 800. In still other embodiments, the depicted circuitry may be part of a one or multiple core complexes, with each complex including a plurality of cores sharing support circuitry such as cache and/or branch prediction circuits (not illustrated).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a processor circuit including:
a mode transition circuit configured to select a particular one of a plurality of processor modes, wherein a given processor mode of the plurality of processor modes corresponds to a respective set of memory access permissions;
a plurality of circuits, including the mode transition circuit, configured to assert respective exception signals; and
an exception management circuit configured to:
receive an indication of an assertion of a particular exception signal by a respective one of the plurality of circuits;
select a vector table of a plurality of vector tables based on a determined processor mode of the plurality of processor modes;
based on the particular exception signal, determine a vector address within the selected vector table; and
based on the determined vector address, retrieve a particular exception handler address from the selected vector table.

2. The apparatus of claim 1, wherein the mode transition circuit is further configured to assert the particular exception signal based on execution of a mode change instruction that requests a mode change from a current processor mode to a requested processor mode.

3. The apparatus of claim 2, wherein the exception management circuit is further configured to:
based on the mode change from the current processor mode to the requested processor mode being allowed, determine the vector address based on the requested processor mode; and
based on the mode change from the current processor mode to the requested processor mode being denied, determine the vector address based on the current processor mode.

4. The apparatus of claim 1, wherein the exception management circuit is further configured to determine the vector address based on a particular privilege level in addition to the determined processor mode and the particular exception signal, and wherein the particular privilege level corresponds to a selected privilege level when the particular exception signal is asserted.

5. The apparatus of claim 4, wherein to determine the vector address, the exception management circuit is further configured to:
use a first base vector address based on a determination the particular privilege level is unprivileged; and
use a second base vector address, different from the first base vector address, based on a determination the particular privilege level is privileged.

6. The apparatus of claim 1, wherein the particular exception signal is associated with a change from a first privilege level to a second privilege level, more privileged than the first privilege level; and wherein the exception management circuit is further configured to determine the vector address based on a particular processor mode associated with the first privilege level.

7. The apparatus of claim 1, wherein the exception management circuit is further configured to:
determine the vector address based on the determined processor mode and the particular exception signal, based on a determination that a first value is stored in a particular processor register; and
determine the vector address based on the particular exception signal, based on a determination that a second value is stored in the particular processor register.

8. The apparatus of claim 1, wherein the processor circuit further includes a memory management unit that is configured to:
perform memory accesses based on a given set of memory access permissions corresponding to a given processor mode; and
access a first instruction indicated by the particular exception handler address without using the given set of memory access permissions.

9. The apparatus of claim 1, further comprising a memory circuit, wherein the plurality of vector tables are stored within a particular address range of the memory circuit, and wherein a subset of table entries from different vector tables of the plurality of vector tables are interleaved within the particular address range.

10. A method, comprising:
operating, by a processor circuit, in a current processor mode of a plurality of processor modes, wherein the current processor mode indicates a particular set of memory access permissions;
receiving, by the processor circuit, an indication of an assertion of a particular exception signal of a plurality of exception signals;
selecting, by the processor circuit using a determined processor mode of the plurality of processor modes, one vector table of a plurality of vector tables;
identifying, by the processor circuit, a particular exception vector of a plurality of exception vectors in the selected vector table; and
issuing, by the processor circuit using the identified particular exception vector, a request for a first instruction of an exception handler routine.

11. The method of claim 10, further comprising asserting, by the processor circuit, the particular exception signal after executing an instruction to change the current processor mode to a requested processor mode.

12. The method of claim 11, further comprising:
based on determining that a change to the requested processor mode is not allowed, preventing, by the processor circuit, the change; and
using, by the processor circuit, the current processor mode to select the one vector table.

13. The method of claim 11, further comprising:
based on determining that a change to the requested processor mode is allowed, changing, by the processor circuit, to the requested processor mode; and
using, by the processor circuit, the requested processor mode to select the one vector table.

14. The method of claim 10, further comprising:
changing, by the processor circuit, a privilege level of the processor circuit from a first privilege level to a second privilege level, more privileged than the first privilege level;
based on the changing of the privilege level, asserting, by the processor circuit, the particular exception signal; and
based on the asserting of the particular exception signal, selecting, by the processor circuit, the one vector table based on a particular processor mode associated with the first privilege level.

15. The method of claim 10, further comprising:
identifying, by the processor circuit, a privilege level of the processor circuit at a time when the particular exception signal is asserted;
determining, by the processor circuit, a base vector address based on the identified privilege level; and
selecting, by the processor circuit using the base vector address, the one vector table based on the determined processor mode.

16. A non-transitory, computer-readable storage medium storing program instructions that include one or more instances of an instruction that is executable by a processor circuit of a computer system to request an agent transition including a change from a current value of an agent index to a new value, a value of the agent index being indicative of a software agent that is currently executing on the processor circuit, wherein execution of a particular instance of the instruction causes the processor circuit to:
assert a particular exception signal of a plurality of exception signals;
based on a particular value of the agent index, determine one vector table of a plurality of vector tables to access;
based on the particular exception signal, access a particular exception vector from the one vector table; and
fetch a first instruction located at an address identified by the particular exception vector.

17. The non-transitory, computer-readable storage medium of claim 16, wherein the execution of the particular instance of the instruction further causes the processor circuit to:
determine whether the requested agent transition is permitted;
based on the requested agent transition being allowed, determine which of the plurality of vector tables to access based on the new value of the agent index; and
based on the requested agent transition being denied, determine which of the plurality of vector tables to access based on the current value of the agent index.

18. The non-transitory, computer-readable storage medium of claim 16, wherein the assertion of the particular exception signal causes the processor circuit to change from an unprivileged level to a privileged level; and
wherein the execution of the particular instance of the instruction further causes the processor circuit to determine which of the plurality of vector tables to access based on a value of the agent index associated with the unprivileged level.

19. The non-transitory, computer-readable storage medium of claim 18, wherein to determine which of the plurality of vector tables to access based on the value of the agent index associated with the unprivileged level, the execution of the particular instance of the instruction further causes the processor circuit to:
determine a base vector address based on the unprivileged level; and
use the base vector address to select the one vector table based on the value of the agent index associated with the unprivileged level.

20. The non-transitory, computer-readable storage medium of claim 16, wherein the execution of the particular instance of the instruction further causes the processor circuit to, based on a first value stored in a particular processor register, determine whether to use the value of the agent index to select the one vector table.
